(19) United States
(12) Patent Application Publication
(10) Pub. No.: US 2012/0120099 A1
(43) Pub. Date: May 17, 2012

(54) IMAGE PROCESSING APPARATUS, IMAGE PROCESSING METHOD, AND STORAGE MEDIUM STORING A PROGRAM THEREOF

(75) Inventor: Daisuke Ishizuka, Kawasaki-shi (JP)

(73) Assignee: CANON KABUSHIKI KAISHA, Tokyo (JP)

(21) Appl. No.: 13/280,809

(22) Filed: Oct. 25, 2011

(30) Foreign Application Priority Data
Nov. 11, 2010 (JP) 2010-252954

(51) Int. Cl. G09G 5/00

(52) U.S. Cl. 345/620

(57) ABSTRACT

Based on a first image and a second image among a plurality of images, a first region in the first image and a second region in the second image are specified. The first region in the first image and the second region in the second image has a correlation with each other. The first image and the second image are displayed based on the specified regions, and a layout for arranging the first image and the second image is determined in accordance with a user instruction via a display screen.

### BACKGROUND OF THE INVENTION

1. Field of the Invention

The present invention relates to an image processing apparatus, an image processing method, and a storage medium storing a program for determining a layout for multiple images.

2. Description of the Related Art

There is known to be technology for determining a layout for multiple images and arranging and outputting multiple images in accordance with the determined layout.

For example, Japanese Patent Laid-Open No. 01-230184 discloses technology for determining portions of overlapping image content in multiple images, joining the multiple images such that the determined overlapping portions overlap each other to generate a single image, and outputting the resultant image.

However, as disclosed in Japanese Patent Laid-Open No. 01-230184, even if a layout for multiple images is determined such that overlapping portions of the images overlap each other, there are cases where the determined layout is not that which the user desires. For example, in the case of aligning two images, if a character included in one image is included multiple times in the other image, it may not be possible to determine which characters are to be aligned with each other. In view of this, the images are displayed on a display screen, and the user can determine the positions of the images by giving an instruction for moving the images on the display screen.

However, it is not always true that the images displayed on the display screen are suited for determining the layout. For example, if information not indicating a correlation between images is only displayed, there are cases where even if the user views the display screen, it is not possible to be aware of which direction and how far images should be moved.

### SUMMARY OF THE INVENTION

An aspect of the present invention is to eliminate the above-mentioned problems with the conventional technology. The present invention provides an image processing apparatus, an image processing method, and a storage medium storing a program that enable appropriate and easy determination of a layout for multiple images.

The present invention in its first aspect provides an image processing apparatus that determines a layout used when combining a plurality of images obtained by imaging a plurality of regions into which one object has been divided, comprising: a specification unit configured to, based on a first image and a second image among the plurality of images, specify a first region in the first image and a second region in the second image, the first region in the first image and the second region in the second image having a correlation with each other; a display control unit configured to cause a display screen to display the first region specified by the specification unit in the first image and the second region specified by the specification unit in the second image; and a determination unit configured to determine a layout to be used in arranging the first image and the second image, in accordance with a user instruction via the display screen.

The present invention in its second aspect provides an image processing method executed in an image processing apparatus that determines a layout used when combining a plurality of images obtained by imaging a plurality of regions into which one object has been divided, the image processing method comprising: specifying, based on a first image and a second image among the plurality of images, a first region in the first image and a second region in the second image, the first region in the first image and the second region in the second image having a correlation with each other; causing a display screen to display the first region specified in the first image and the second region specified in the second image; and determining a layout to be used in arranging the first image and the second image, in accordance with a user instruction via the display screen.

The present invention in its third aspect provides a storage medium storing a program for causing a computer to execute an image processing method executed in an image processing apparatus that determines a layout used when combining a plurality of images obtained by imaging a plurality of regions into which one object has been divided, the image processing method comprising: specifying, based on a first image and a second image among the plurality of images, a first region in the first image and a second region in the second image, the first region in the first image and the second region in the second image having a correlation with each other; causing a display screen to display the first region specified in the first image and the second region specified in the second image; and determining a layout to be used in arranging the first image and the second image, in accordance with a user instruction via the display screen.

According to the present invention, the user can appropriately and easily determine a layout for multiple images.

Further features of the present invention will become apparent from the following description of exemplary embodiments with reference to the attached drawings.

### BRIEF DESCRIPTION OF THE DRAWINGS

FIG. 1 is a diagram showing the configuration of an image processing apparatus used in an embodiment of the present invention.

FIGS. 2A and 2B are diagrams showing examples of screens for loading and combining images.

FIGS. 3A and 3B are diagrams showing examples of screens for joining images.

FIGS. 4A and 4B are diagrams illustrating the detection of similar regions according to Embodiment 1.

FIGS. 5A and 5B are other diagrams illustrating the detection of similar regions.

FIGS. 6A and 6B are first diagrams illustrating a procedure of operations performed on a user interface.

FIGS. 7A and 7B are second diagrams illustrating the procedure of operations performed on the user interface.

FIG. 8 is a third diagram illustrating the procedure of operations performed on the user interface.

FIG. 9 is a flowchart showing a procedure of image joining processing.

FIGS. 10A and 10B are diagrams illustrating the detection of similar regions according to Embodiment 2.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

### Embodiment 1

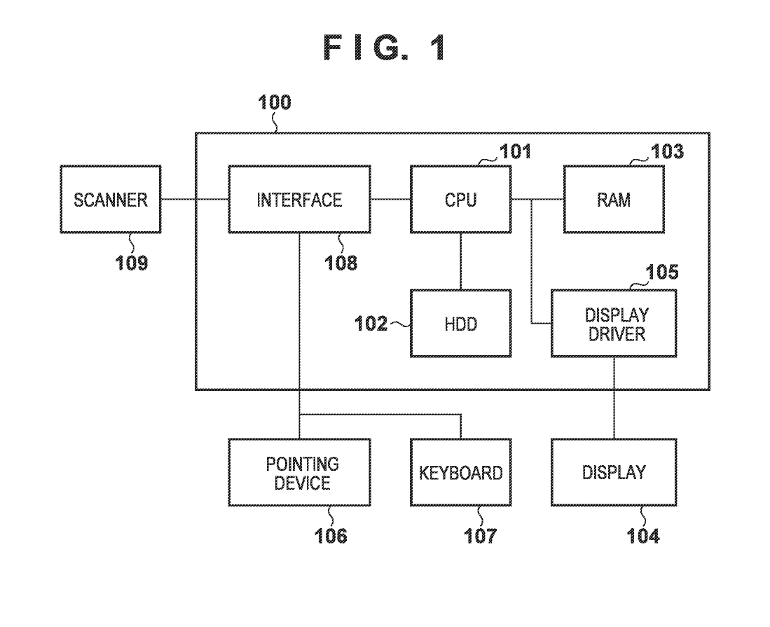

FIG. 1 is a diagram showing the configuration of an image processing apparatus used in an embodiment of the present invention. An image processing apparatus 100 is a PC or the like. A CPU 101 controls blocks that will be described below, and develops a program read from a hard disk (HDD) 102, a ROM (not shown), or the like to a RAM 103 and executes the program. The HDD 102 stores image data and a program for the execution of processing shown in a flowchart that will be described later. A display 104 displays a user interface of the present embodiment, and a display driver 105 controls the display 104. A user can perform operations on the user interface using a pointing device 106 and a keyboard 107. An interface 108 controls a scanner 109, and the scanner 109 acquires image data by reading an image of an original document placed on a platen.

In the example given in the present embodiment, one original document that is larger than the platen of the scanner is repeatedly read portion-by-portion, and the acquired images are combined so as to acquire an image corresponding to the original document. Note that in the present embodiment, when reading is performed multiple times, it is assumed that overlapping portions of the original document will be read.

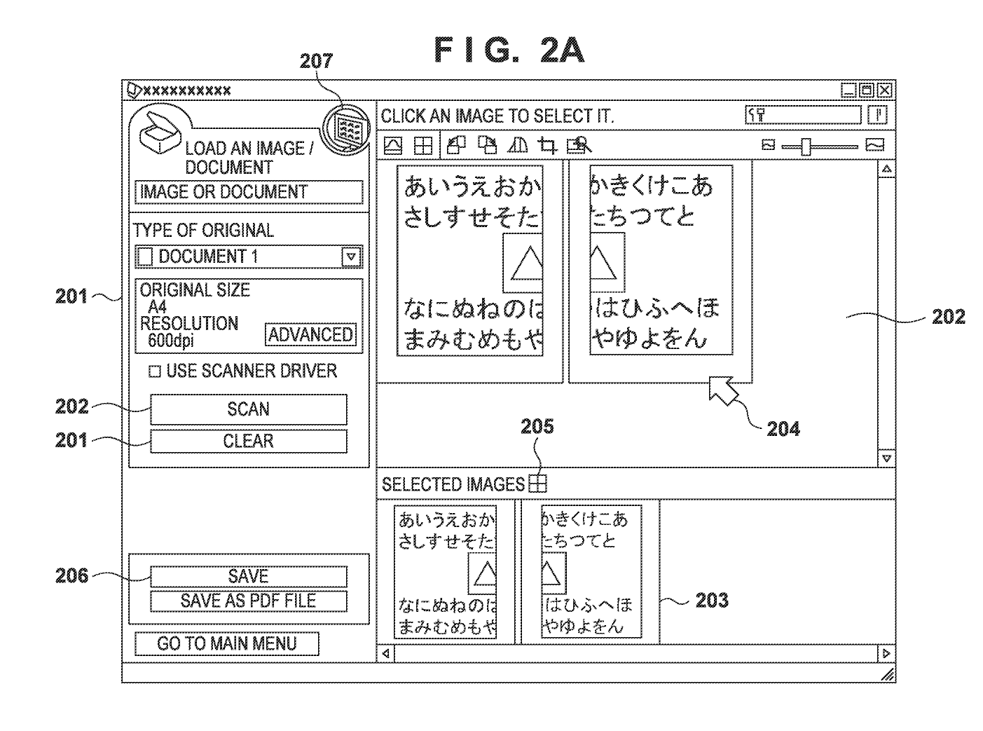

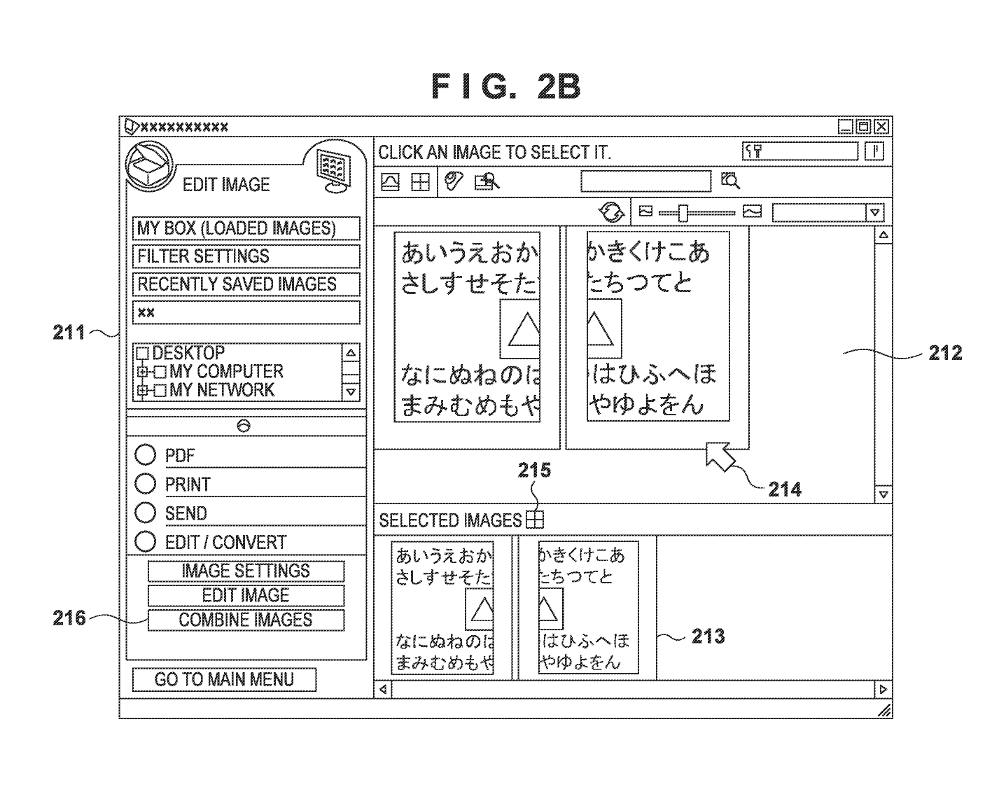

The following describes a user interface displayed on the display 104 according to the present embodiment. FIG. 2A is a diagram showing an example of a screen for loading images from the scanner 109. A display 201 is used when setting the resolution and the like for the reading of images by the scanner 109. A display 202 displays thumbnail images corresponding to image data read by the scanner 109. A display 203 displays images selected from among the thumbnail images displayed in the display 202. A cursor 204 enables the selection of a thumbnail image displayed in the display 202. A display 205 is a button for canceling a selection made using the cursor 204. A display 206 is a button for storing the image corresponding to the thumbnail image selected by the cursor 204 in the image processing apparatus 100. A display 207 is a button for transitioning to the image selection screen shown in FIG. 2B.

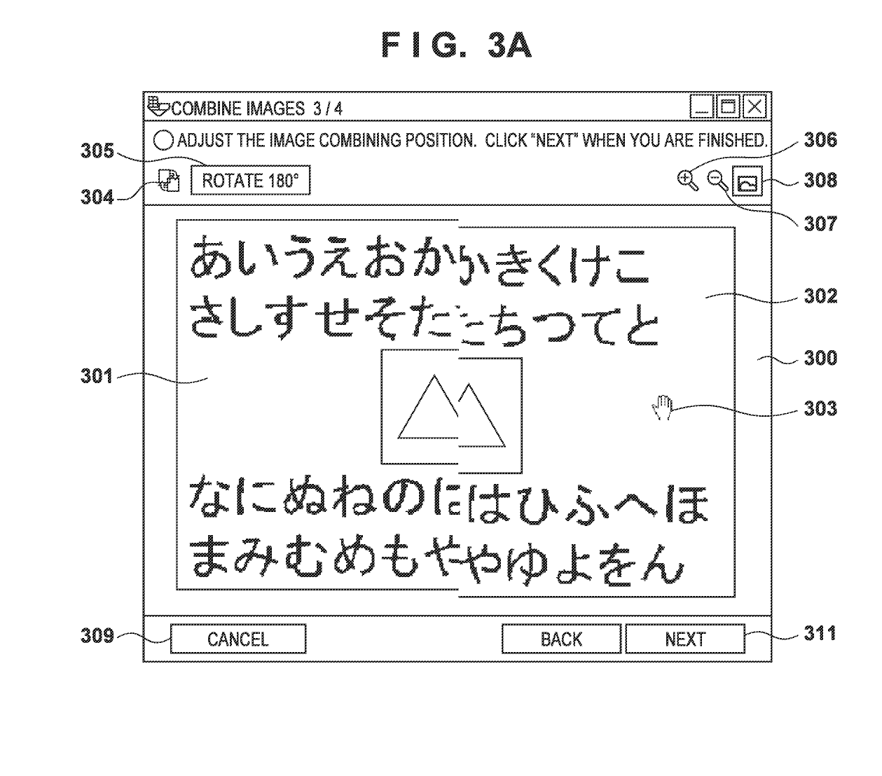

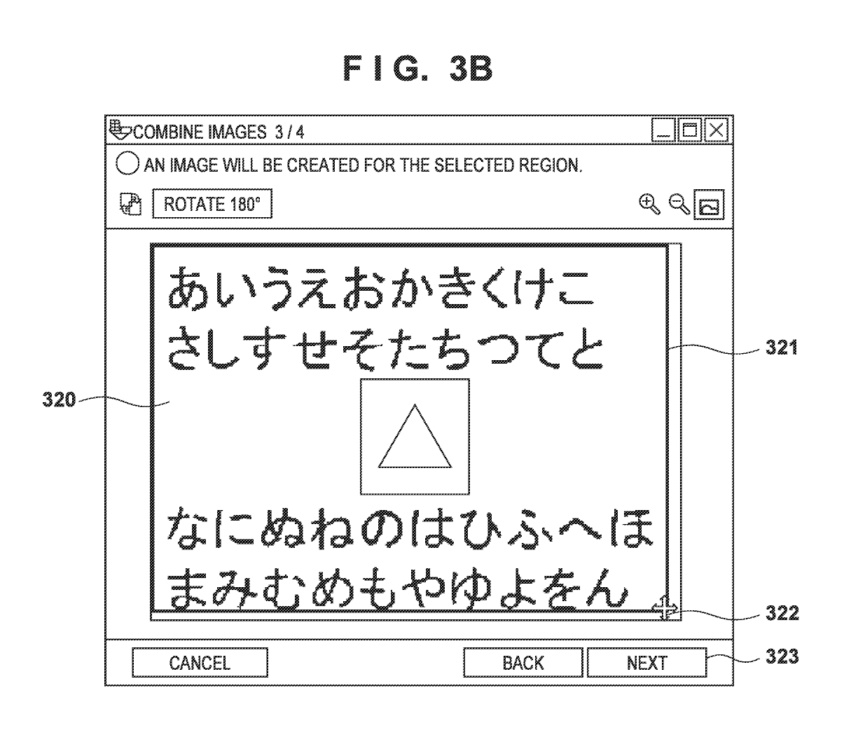

FIG. 2B is a diagram showing an example of a screen for combining images. A display 211 displays a tree view for designating a folder storing images read by the scanner 109. A display 212 displays thumbnail images corresponding to image data stored in the folder designated in the display 211. A display 213 displays images selected from among the thumbnail images displayed in the display 212. A cursor 214 enables the selection of a thumbnail image displayed in the display 212. A display 215 is a button for canceling a selection made using the cursor 214. A display 216 is a button for transitioning to a screen shown in FIGS. 3A and 3B for combining images selected by the cursor 214. Hereinafter, in the present embodiment, the combining of images is also referred to as “joining”.

FIG. 3A is a diagram showing an example of a screen for joining images. This diagram shows an example of joining two images, namely a first image 301 and a second image 302. Although the images 301 and 302 are normally quadrilateral as shown in FIG. 3A, the images may have any shape as long as the outer edge is a polygon. As shown in FIG. 3A, the images 301 and 302 are displayed side-by-side so as to share an edge, without allowing overlapping. A display 300 displays the images 301 and 302. A cursor 303 enables joining the images 301 and 302 by dragging the image 302 so as to align it. A display 304 is a button for switching the displayed positions of the images 301 and 302. A display 305 is a button for rotating the image 302 by 180 degrees and displaying the resultant image. A display 306 is a button for performing enlarged display of the images displayed in the display 300, and a display 307 is a button for performing reduced display of the images displayed in the display 300, both of which are normally used buttons.

A display 308 is a button for enlarging the display in the present embodiment. If the display 308 is pressed and furthermore the pointing device 106 is pressed at a position over the image 301 or the image 302, multiple similar regions are specified by detecting similar shapes and sizes in a predetermined region in the vicinity of where the images 301 and 302 are to be joined. Furthermore, the image displayed in the display 300 is displayed at the maximum size at which the display 300 includes the position designated by the cursor 303 and the similar regions that were detected and displayed so as to be identifiable. The similar region detection method and the enlarging of images will be described later.

A display 309 is a button for canceling the joining operation of the present embodiment and closing the screen shown in FIG. 3A. A display 311 is a button for transitioning to the screen shown in FIG. 3B for designating a crop region when the joining operation of the present embodiment has ended.

FIG. 3B is a diagram showing an example of a screen for designating a crop position. An image 320 is the image obtained when the joining operation of the present embodiment has ended. A display 321 indicates a crop region (cut-out region) in the image 320. A cursor 322 enables changing the size of the crop region by dragging a corner of the display 321 indicating the crop region. The cursor 322 also enables changing the position of the crop region by dragging a side of the display 321. A display 323 is a button for confirming the image 320 that has undergone the joining of the present embodiment and has been cropped in accordance with the display 321.

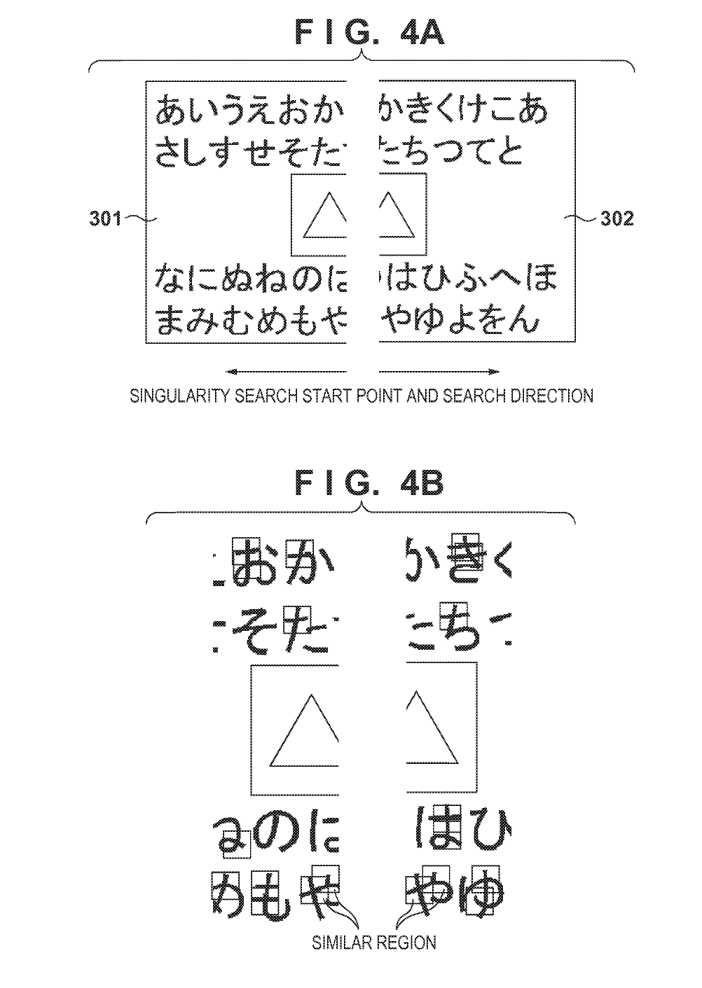

FIGS. 4A and 4B are diagrams illustrating the detection of similar regions in the images 301 and 302. First, when the display 308 shown in FIG. 3A is pressed, the image processing apparatus 100 extracts pixels (singularities) for which the amount of change in density relative to surrounding pixels is large, in the directions (the arrows shown in FIG. 4A) moving away from the edge at which the images 301 and 302 were combined. Accordingly, an extracted singularity group can indicate the contours (edges) of characters, for example. Among the extracted singularity groups, regions in which the alignment of a singularity group in the X direction (horizontal direction of the image) and the alignment of a singularity group in the Y direction (vertical direction of the image) are substantially the same in the images 301 and 302 are detected as similar regions. Here, if it is determined that the alignments of singularity groups are substantially the same, first the X-direction and Y-direction positions of the singularity group in each of the images are acquired. The X-direction and Y-direction positions of the singularity groups in the images are compared, and it is detected that the alignments of the singularity groups are substantially the same if the positional relationships of the singularity groups in the images are similar to each other.

A degree of similarity is then determined for the images based on the positional relationships of the singularity groups included in the images. Similar regions are then specified based on the determined degree of similarity. Note that in the case where multiple similar regions are detected, it is possible to, for example, determine regions as being similar regions if the degree of similarity is greater than a predetermined threshold value, or determine regions having the highest degree of similarity as being similar regions.

Also, in the case of determining the degree of similarity of singularity groups, it is possible to detect the tilt of the original document when it was read, rotate the read image in accordance with the detected tilt, and compare a singularity group in the rotated image with a singularity group in the other image. This enables precisely detecting similar regions even if, for example, the original document is placed obliquely on the platen when the user reads the original document with a scanning apparatus. Note that the method of detecting the tilt of the original document may be a known method such as a method of detecting tilt by detecting edges of the original document.

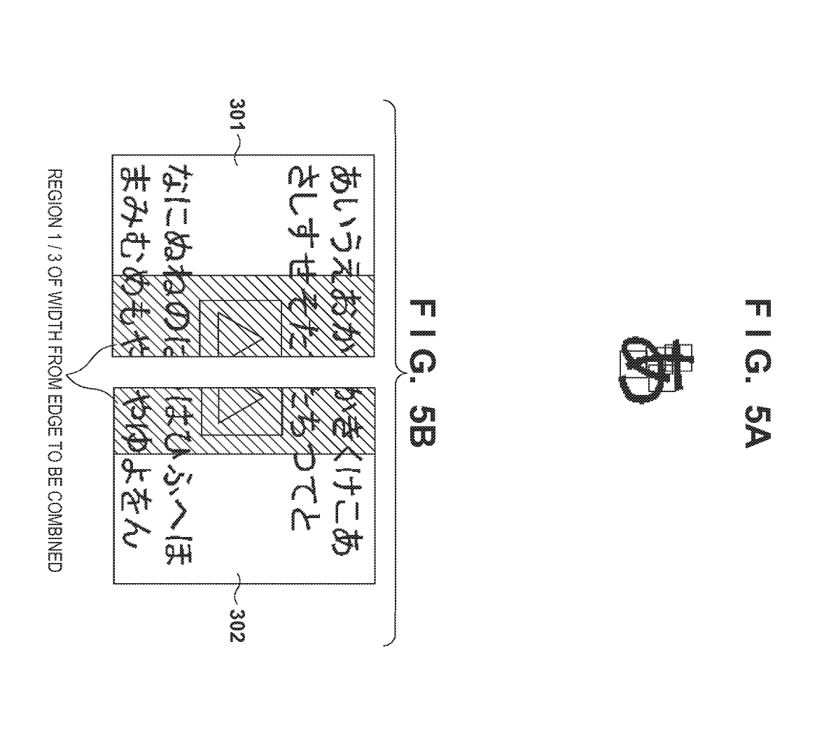

FIG. 4B is a diagram showing an example of similar regions. In FIG. 4B, similar regions appearing in the images 301 and 302 are shown enclosed in squares. Specifically, although the actual characters including squares are different from each other, the regions enclosed by the squares (portions of characters) each have a shape similar to a cross-like shape. For example, in the case of the character “ [symbol] ” (hiragana “ya”), the shapes (cross-like shapes) of two portions including intersections in “ [symbol] ” (hiragana “ya”) are similar to each other. Also, FIG. 5A shows similar regions in the character “ [symbol] ” (hiragana “a”). As shown in FIG. 5A, regions in the vicinity of four intersections in the character “ [symbol] ” (hiragana “a”) are detected as similar regions.

The user can easily determine a layout according to which the similar regions overlap each other by moving the images displayed on the display screen indicating similar regions, such that the regions enclosed in squares overlap each other.

Note that in the case of detecting similar regions after rotating an image as described above, there are cases where the tilt of similar regions are different between images. In such a case, the squares enclosing the singularity groups are also displayed rotated on the display screen. This allows the user to recognize the fact that the tilts of similar regions are different between the images. Then, in the case of outputting the images, at least one of the images is automatically rotated so as to align the tilts of the similar regions before performing output.

Alternatively, in the case where the tilts of similar regions are different between images, it is possible to rotate at least one of the images such that the similar regions overlap, and perform enlarged display of a portion including the similar regions. In such a case, the user can check the layout of the images with the angles of the images being aligned. Then, when outputting the images, there is no need to rotate an image in order to align the tilts of the images, thus enabling suppressing the load of processing from the determination of the layout for multiple images to the output of an image.

Furthermore, in the case where the tilts of images differ, there is no limit to automatic rotation of an image, and it possible for the user to rotate an image while checking the images displayed on the display screen. Here, it is also possible to detect similar regions after the user has rotated an image so as to correct its tilt.

Here, in the case where similar regions have been detected in the images 301 and 302 as shown in FIG. 5B, the character “ [symbol] ” (hiragana “a”) positioned at the top left in the image 301, for example, is also targeted for similar region detection as shown in FIG. 5A. However, in the present embodiment, similar region detection is performed only in regions determined by a predetermined length in the direction of the arrows shown in FIG. 4A from the edge where the images 301 and 302 are joined, as shown by the hatched portions in FIG. 5B. In the present embodiment, the images 301 and 302 that are targeted for combining are images obtained by a scanning apparatus reading a single original document multiple times. Incidentally, it is thought that the user will read the original document in portions divided according to the size of the platen in order to reduce the number of times reading is performed. In this case, it is thought that a region at the edge of one read image will include a region similar to that of another image. In view of this, in the present embodiment, the erroneous detection of similar regions is prevented by limiting the range for detecting similar regions in the images to regions at image edges instead of the entire image. Limiting the regions where similar regions are detected also enables reducing the load of processing for detection.

In the present embodiment, it is assumed that the length of the region in which similar regions are detected is set as one-third of the horizontal width of an image from the edge joined to another image. For this reason, in the example shown in FIG. 3B, the character “ [symbol] ” (hiragana “a”) positioned at the top left in the image 301 is not targeted for similar region detection, and the load of processing performed by the CPU 101 of the image processing apparatus 100 is further reduced. Also, if similar regions are not detected in the regions determined to have a length of one-third of the horizontal width of the image, similar region detection may be performed in a similar region detection region that has been enlarged by changing the length to one-half of the horizontal width, for example.

Also, when detecting similar regions in images, it is possible to interrupt the similar region detection processing if even one similar region has been detected, and then perform display processing. Accordingly, it is possible to proceed to display processing without performing similar region detection processing on the entire edge of each image, thus enabling suppressing the load of processing for displaying similar regions.

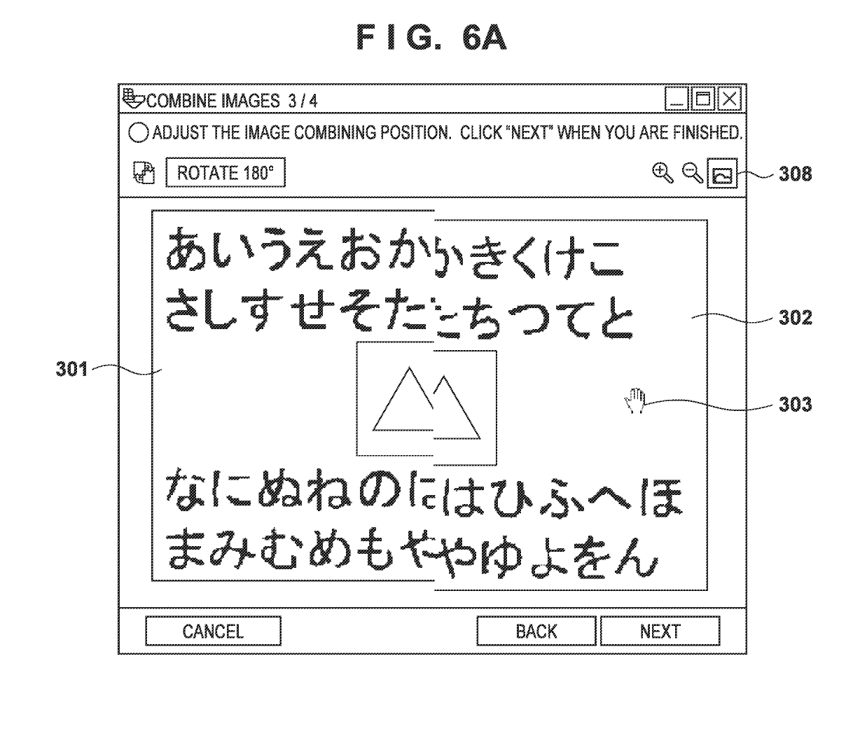

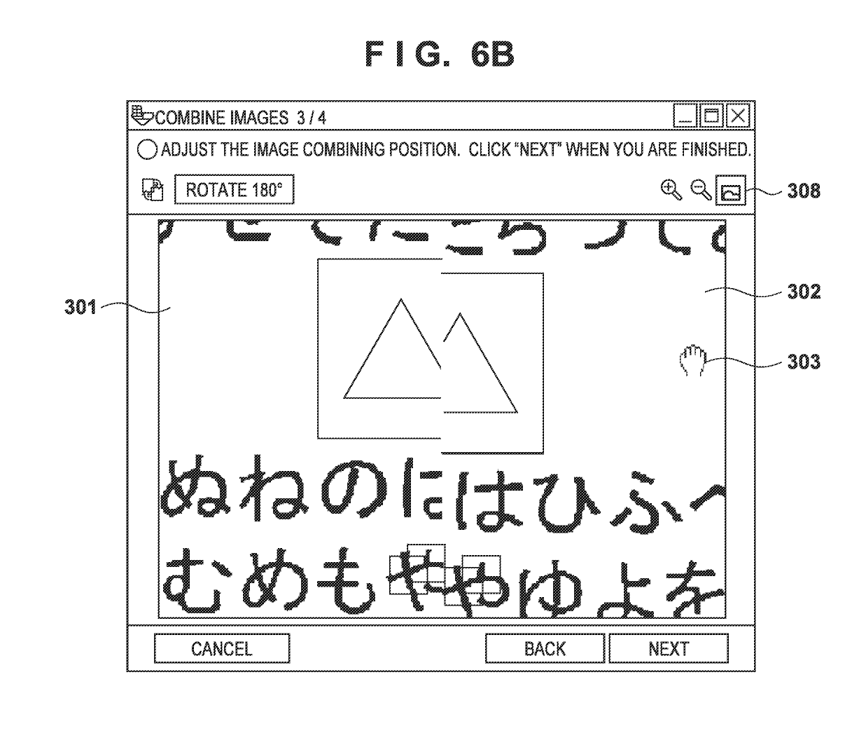

Next is a description of an example of operations for user interface display control performed by the image processing apparatus 100 of the present embodiment with reference to FIGS. 6A to 8.

FIG. 6A shows the same state as that shown in FIG. 3A. Specifically, this is the state before the joining operation of the present embodiment has been performed. In FIG. 6A, the cursor 303 is displayed, but the user has not yet pressed a button of the pointing device 106 (the cursor 303 is displayed as an “open hand”). When the user presses the button of the pointing device 106 while the cursor 303 is positioned over the image 302 as shown in FIG. 6A, processing for detecting similar regions in the images is executed as described above. Here, similar regions included in the character “ [symbol] ” (hiragana “ya”) are then detected, and the user interface transitions to the state shown in FIG. 6B. In FIG. 6B, the cursor 303 is displayed as a “grabbing hand”. At this time, the image is automatically displayed enlarged to the maximum size at which the display includes the cursor 303 and the similar regions included in the hiragana character “ [symbol] ” (hiragana “ya”). Also, at this time, the similar regions included in the character “ [symbol] ” (hiragana “ya”) are displayed enclosed in a square or the like so as to be able to be identified among other previously detected similar regions. In this way, if the button of the pointing device 106 is pressed and multiple similar regions are detected in the state shown in FIG. 6A, some similar regions among the detected similar regions are displayed in an emphasized state in FIG. 6B so as to be distinguishable from the other similar regions. For example, among all of the similar regions, the largest similar regions are selected as the similar regions to be displayed in an emphasized manner. The display may then be enlarged to the maximum size at which the display includes the selected similar regions and the cursor 303.

Also, if multiple similar regions have been detected, it is possible to perform display processing so as to show the multiple similar regions and allow the user to select any of the similar regions. The display may then be enlarged while including the selected similar regions.

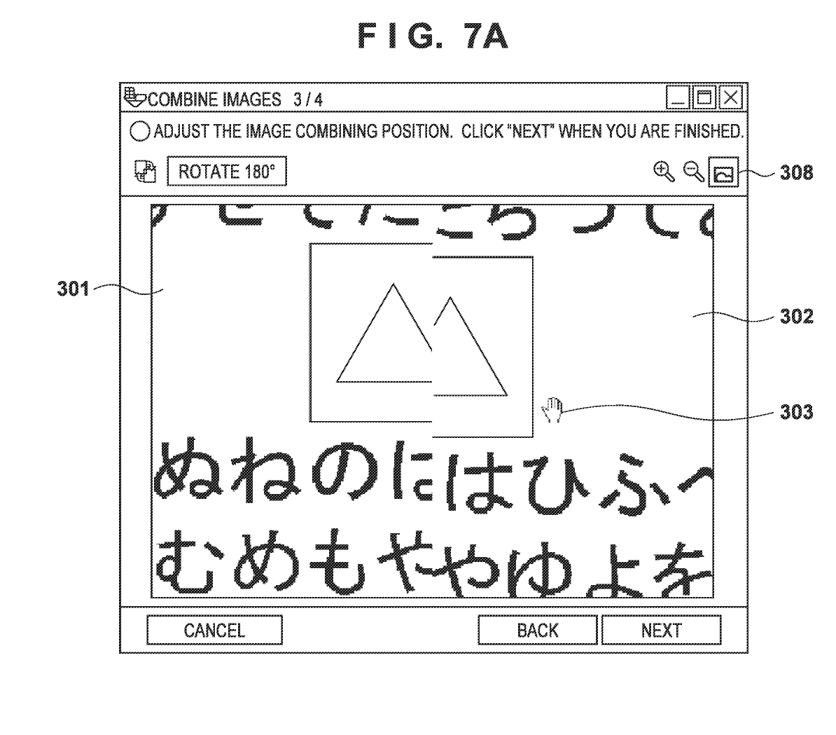

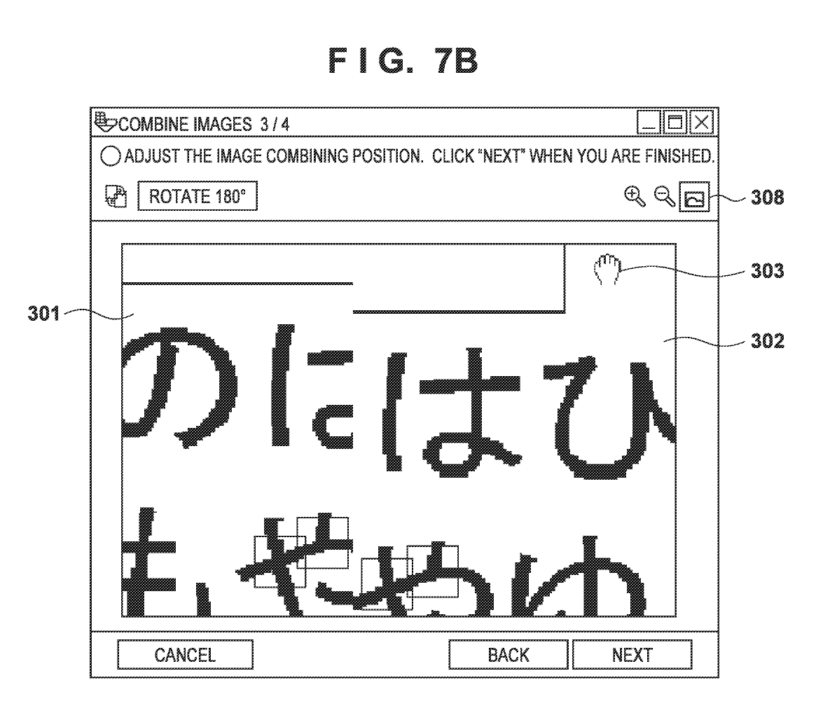

FIG. 7A is a diagram showing the state of the user interface after the user has stopped pressing the button of the pointing device 106 in the state shown in FIG. 6B and moved the cursor 303 to the vicinity of the center of the screen in order to perform an aligning operation. As shown in FIG. 7A, the cursor 303 is displayed as an “open hand”. When the button of the pointing device 106 is pressed in the state shown in FIG. 7A, the user interface transitions to the state shown in FIG. 7B, in which the state shown in FIG. 7A has been further enlarged. In FIG. 7B, the cursor 303 is displayed as a “grabbing hand”. At this time, the image is automatically displayed further enlarged to the maximum size at which the display includes the cursor 303 and the similar regions included in the hiragana character “ [symbol] ” (hiragana “ya”). Similarly to FIG. 6B, the similar regions are displayed enclosed in squares so as to be identifiable in FIG. 7B as well.

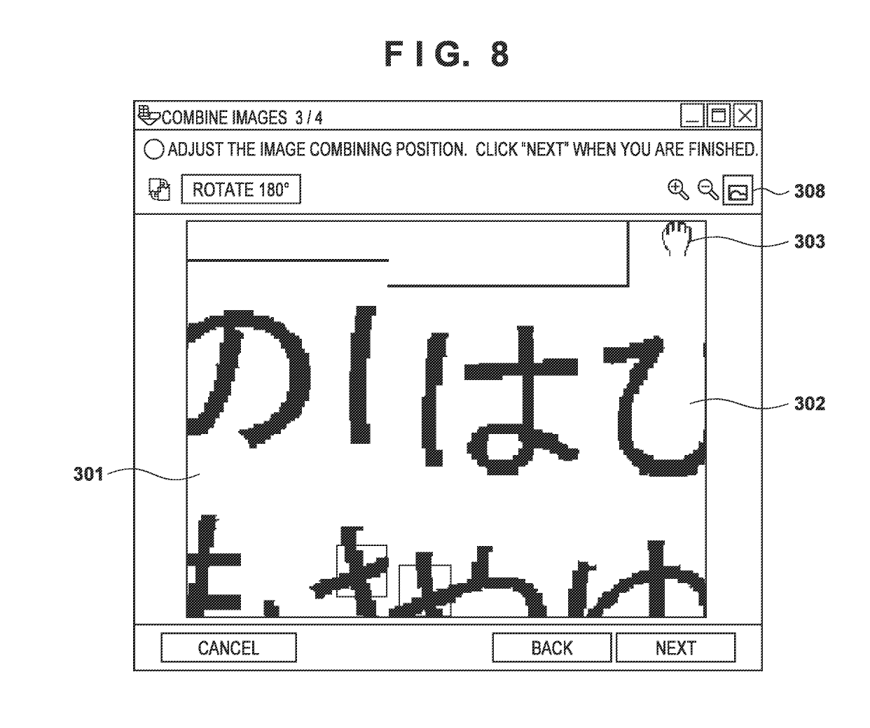

FIG. 8 is a diagram showing the state in which the button of the pointing device 106 is pressed and held in the state shown in FIG. 7B (the cursor 303 maintains the “grabbing hand” state), and the image 302 has been dragged so as to overlap the image 301. If the cursor 303 is furthermore moved to the vicinity of the center, and the button of the pointing device 106 is pressed in the state shown in FIG. 8, image enlargement and similar region display are performed again, similarly to the states shown in FIGS. 6B and 7B.

In this way, the user can perform an operation for joining the images 301 and 302 displayed on the user interface through merely operating the button of the pointing device 106. This consequently eliminates the need for the user to repeatedly operate a conventional enlarge/reduce button and then perform an aligning operation using the cursor, and enables easily aligning multiple images.

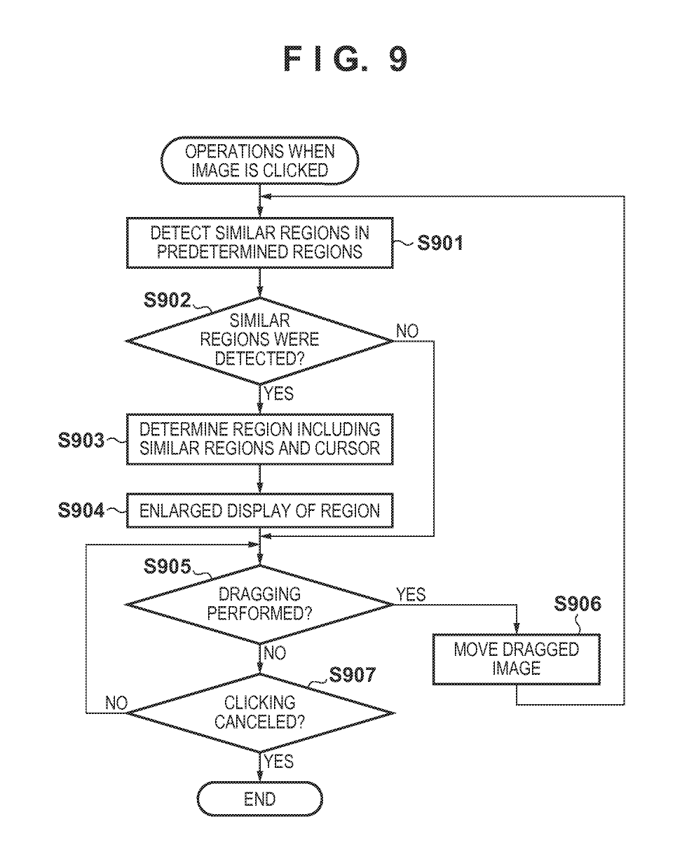

FIG. 9 is a flowchart showing a procedure of image joining processing of the present embodiment, including the processing illustrated in FIGS. 6A to 8. Note that in the present embodiment, the processing shown in FIG. 9 is executed by the CPU 101 reading out and executing a program corresponding to this processing that is stored in a ROM or the like.

In the case where the user interface is in the state shown in FIG. 3A, if the button of the pointing device 106 is pressed while the cursor 303 is positioned over the image 301 or the image 302, similar regions are detected within a predetermined region (S901). The predetermined region referred to here is the region indicated by hatching in FIG. 5B. In S902, it is determined whether similar regions were detected. If it has been determined that similar regions were detected, the procedure advances to S903. On the other hand, if it has been determined that no similar regions were detected, the procedure advances to S905. The detection of similar regions is performed as illustrated in FIGS. 4A to 5B. In S903, a region including the similar regions and the cursor 303 is determined, and in S904, enlarged display of the determined region is performed. The processing in S903 and S904 is performed as illustrated in FIGS. 6B and 7B. As shown in FIG. 9, enlarged display is not performed if similar regions were not detected (S902:NO).

In S905, it is determined whether the cursor 303 was dragged. This dragging refers to the drag operation illustrated in FIG. 8. The procedure advances to S906 if it has been determined that the cursor 303 was dragged, and advances to S907 if it has been determined that the cursor 303 was not dragged. In S906, the image is moved as illustrated in FIG. 8, and processing is repeated from S901. In S907, it is determined whether the pressing of the button of the pointing device 106 was canceled. The processing of this procedure ends if the user has canceled the pressing of the button of the pointing device 106 upon, for example, determining that desired joining has been realized. On the other hand, if the pressing of the button of the pointing device 106 has not been canceled, the images continue to be moved by dragging, and therefore the determination processing of S905 is repeated.

In this way, multiple images are display in S901 as shown in FIG. 3A, and enlarged display including similar regions is performed in S904 in accordance with an instruction given by the user. Note that there is no need for multiple images to be displayed as shown in FIG. 3A when the user gives an enlarged display instruction, and a configuration is possible in which images are first displayed in S904 after the user has given the enlarged display instruction.

Also, the timing of the detection of similar regions in S901 is not limited to the timing of the input of a user instruction, and the detection of similar regions and enlarged display may be performed in accordance with the reading of multiple images.

### Embodiment 2

The image processing apparatus 100 of the present embodiment includes a dictionary for character recognition (OCR) in the HDD 102 show in FIG. 1. This enables recognizing characters included in the images 301 and 302 that are to be joined.

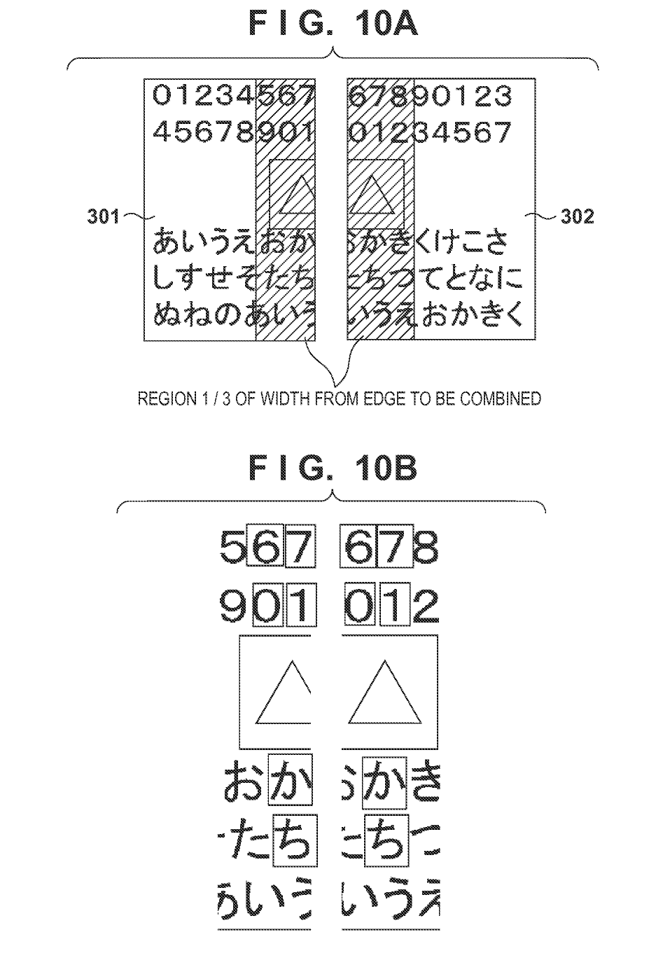

FIGS. 10A and 10B are diagrams illustrating the detection of similar regions according to the present embodiment. If the user positions the cursor 303 over the image 301 or the image 302 and presses a button of the pointing device 106, the following processing is performed. First, as shown in FIG. 10A, the image processing apparatus 100 performs OCR processing in predetermined regions having a length of one-third of the image width from the edge to be combined. These regions are the same as those illustrated in FIG. 5B.

If any of the characters recognized by the OCR processing match between the images 301 and 302, such characters are displayed enclosed in a square as shown in FIG. 10B. For example, in FIG. 10B, “6” and “6” are detected as similar regions, and “ [symbol] ” (hiragana “ka”) and “ [symbol] ” (hiragana “ka”) are detected as similar regions. At this time, the detection of similar regions through OCR processing is not performed outside the predetermined regions shown in FIG. 10A.

As described above, the present embodiment differs from Embodiment 1 in that the detection of similar regions is performed in units of characters. Although the example of the two images 301 and 302 has been described in Embodiments 1 and 2, the present invention is applicable to the case of three images as well. In the case of three images, a configuration is possible in which predetermined regions are obtained based on the edge to be combined for each combination of two images, an overall logical sum is obtained from the predetermined regions, and the detection of similar regions is performed in the regions obtained by the logical sum. Enlarged display and the movement of images by a drag operation are performed as described in Embodiment 1.

After determining a layout for multiple images by moving the images on the display screen as described in the above embodiments, the images are output in accordance with the determined layout.

For example, a configuration is possible in which, after performing enlarged display of the images and determining the relative positions (layout) of the images as described above, the enlarged display is canceled, and the entirety of each image is displayed. The images displayed at this time are displayed at positions that are in accordance with the determined layout.

Furthermore, a configuration is possible in which, after a layout for multiple images is determined, the images are output to a printing apparatus and printing is performed. Here, a single image is obtained by arranging the multiple images in accordance with the determined layout, and the single image is output to the printing apparatus so as to be printed. Alternatively, a configuration is possible in which, for example, multiple images and information indicating a layout determined for multiple images are transmitted to the printing apparatus, and the printing apparatus positions and prints the images in accordance with the layout indicated by the received information.

Note that in the case of moving multiple images displayed on the display screen as in the above embodiments, it is possible to move both of the images or to move only one of the images. Even in the case of moving only one of the images, it is possible to designate the relative positions of both of the images.

Also, although the case of displaying two images is described in above embodiments, the present invention is not limited to this, and a configuration is possible in which three or more images are displayed on the display screen, and a layout is determined for the three or more images.

Furthermore, the case of receiving an input of multiple images obtained by reading a single original document multiple times is described in the above embodiments. However, the present invention is not limited to this, and a configuration is possible in which the multiple images that are received as input have been obtained by imaging a single object in portions over a plurality of times. For example, a configuration is possible in which a single subject is imaged in portions over a plurality of times, and a panorama image is created by combining the captured photograph images. In this case, specifying similar regions in the photograph images and, for example, performing enlarged display of the specified portions enables the user to easily determine whether the position of the photograph images is to be changed.

Note that in the above embodiments, processing is performed by the PC 100 displaying images on the external display 104 and receiving an input of user instructions given using the pointing device 106 or the keyboard 107. However, there is no limitation to this, and a configuration is possible in which processing is performed by images being displayed on the display of a printer, a digital camera, or the like, and the user operating an operation unit with which the printer, digital camera, or the like is provided.

Also, the example of displaying multiple images on the display screen and thereafter moving the images on the display screen in accordance with a user instruction is given in the above embodiments. However, there is no limitation to moving the images, and a configuration is possible in which a screen for allowing the user to confirm the positions where images are to be positioned is displayed. Then, based on this screen, the user gives an instruction for determining whether the images are to be output in accordance with the layout shown in the displayed screen. According to the present invention, similar regions in multiple images are displayed in an enlarged manner, thus making it possible for the user to accurately be aware of the layout to be used when outputting the images.

Furthermore, although combining is performed after having determined a layout by moving images in accordance with a user instruction in the above embodiments, the present invention is not limited to this, and images may be automatically combined such that similar regions overlap each other.

For example, a configuration is possible in which similar regions are detected in images, and thereafter the images are automatically combined such that the similar regions overlap each other, in accordance with an instruction given by the user. In this case, the similar regions that will overlap when automatically combined may be displayed in an emphasized manner so as to be distinguishable from other similar regions. As a result of this emphasized display, even if a large number of similar regions have been detected, the user can instruct the automatic combining of images after having checked the similar regions that will overlap each other when the images are combined.

Also, as another example of the automatic combining of images, a configuration is possible in which, for example, images are combined and displayed such that similar regions overlap each other, and the user is given an inquiry as to whether the displayed layout is to be determined. If the user has instructed the determination of the layout, the images are output in accordance with the determined layout. Also, if the user has given an instruction for canceling the automatically determined layout, the layout determination processing may be canceled, or a screen for moving the images may be displayed as shown in FIGS. 6A to 8. The layout is then determined by moving the images on the display screen in accordance with user instructions as described in the above embodiments.

Note that although enlarged display of multiple images is performed in accordance with similar regions that have been specified in the images, and information indicating the similar regions is added to the display in the above embodiments, a configuration is possible in which either only the images are enlarged or only the aforementioned information is added to the display. Specifically, the similar regions may be displayed without enlarging the images, or the images may be displayed in an enlarged manner including the similar regions, without displaying the similar regions. In either case, display is performed such that the user can make a determination regarding the similar regions in each of the images.

Also, in the above embodiments, similar regions in multiple images are detected based on the assumption that overlapping portions exist in the images, and a display region including the detected similar regions is displayed. However, the present invention is not limited to specifying similar regions, and it is sufficient to be able to specify regions that have a correlation with each other in multiple images by acquiring and comparing the content of the images. This correlation may be regions that are common to multiple images as with the case of the similar regions, or regions that are continuous spanning multiple images.

In the case of regions that are continuous spanning multiple images, a configuration is possible in which, for example, if multiple images including text are to be combined, the spaces between lines of the text included in the images are specified. In general, text included in a document is often arranged at positions with the same line spacing therebetween. In view of this, if the spaces between lines of text included in each image are specified, and the specified spaces between lines are displayed, the user can easily become aware of the position of the images and determine whether the position of the images is to be changed. Also, a layout for multiple images can be appropriately and easily determined by moving the images so as to cause the spaces between lines to match in accordance with the positions of the spaces between lines of text included in the images displayed on the display screen.

Alternatively, in the case of combining multiple photograph images, a configuration is possible in which a region including a straight line that is continuous across the photograph images is detected in each photograph image. In this case, the user can become aware of the positional relationship of the photograph images by checking the regions including the straight line in the photograph images displayed on the display screen.

In this way, displaying multiple images based on regions that have a correlation with each other makes it possible for the user to accurately and easily become aware of the position of the images.

Furthermore, the example of superposing portions of multiple images when combining the images is given in the above embodiments. However, the present invention is not limited to this, and a configuration is possible in which multiple images are combined into one image without superposing the images. For example, multiple images may be combined into one image by arranging them so as to be in contact with each other, or multiple images may be combined into one image by arranging them so as to be spaced apart from each other and allocating predetermined image data to the space between the images.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-252954, filed Nov. 11, 2010, which is hereby incorporated by reference herein in its entirety.

What is claimed is:

1. An image processing apparatus that determines a layout used when combining a plurality of images obtained by imaging a plurality of regions into which one object has been divided, comprising:
a specification unit configured to, based on a first image and a second image among the plurality of images, specify a first region in the first image and a second region in the second image, the first region in the first image and the second region in the second image having a correlation with each other;
a display control unit configured to cause a display screen to display the first region specified by the specification unit in the first image and the second region specified by the specification unit in the second image; and
a determination unit configured to determine a layout to be used in arranging the first image and the second image, in accordance with a user instruction via the display screen.

2. The image processing apparatus according to claim 1,
wherein the display control unit enlarges a partial display region in the first image and the second image, and causes the enlarged display regions to be displayed on the display screen, the enlarged display regions including the first region and the second region.

3. The image processing apparatus according to claim 1,
wherein the display control unit adds, to the first image and the second image, information indicating the first region and the second region, and causes the first image and the second image having the information to be displayed on the display screen.

4. The image processing apparatus according to claim 1, further comprising:
a movement control unit configured to, in accordance with a user instruction, causes at least one of the first image and the second image displayed on the display screen by the display control unit to be moved on the display screen,
wherein the determination unit determines the layout to be used in arranging the first image and the second image, in accordance with positions of the images moved by the movement control unit on the display screen.

5. The image processing apparatus according to claim 1,
wherein the specification unit specifies a similar regions in respective images of the plurality of images, the similar regions being regions that are similar between the first image and the second image.

6. The image processing apparatus according to claim 1,
wherein the display control unit cause the display screen to display the first image and the second image in an overlapping manner such that the regions specified by the specification unit overlap each other, and
in accordance with the user instruction, the determination unit determines the layout used in arranging the first image and the second image.

7. The image processing apparatus according to claim 1, further comprising:
an output control unit configured to perform control such that the first image and the second image are output in accordance with the layout determined by the determination unit.

8. The image processing apparatus according to claim 7,
wherein the output control unit performs control so as to display the first image and the second image on the display screen such that the first image and the second image are displayed in accordance with the layout determined by the determination unit.

9. The image processing apparatus according to claim 7,
wherein the output control unit performs control so as to cause the first image and the second image to be printed by a printing apparatus such that the first image and the second image are printed in accordance with the layout determined by the determination unit.

10. An image processing method executed in an image processing apparatus that determines a layout used when combining a plurality of images obtained by imaging a plurality of regions into which one object has been divided, the image processing method comprising:
specifying, based on a first image and a second image among the plurality of images, a first region in the first image and a second region in the second image, the first region in the first image and the second region in the second image having a correlation with each other;
causing a display screen to display the first region specified in the first image and the second region specified in the second image; and
determining a layout to be used in arranging the first image and the second image, in accordance with a user instruction via the display screen.

11. A storage medium storing a program for causing a computer to execute an image processing method executed in an image processing apparatus that determines a layout used when combining a plurality of images obtained by imaging a plurality of regions into which one object has been divided,
the image processing method comprising:
specifying, based on a first image and a second image among the plurality of images, a first region in the first image and a second region in the second image, the first region in the first image and the second region in the second image having a correlation with each other;
causing a display screen to display the first region specified in the first image and the second region specified in the second image; and
determining a layout to be used in arranging the first image and the second image, in accordance with a user instruction via the display screen.
